(19) United States
(12) Patent Application Publication
(10) Pub. No.: US 2007/0151659 A1
(43) Pub. Date: Jul. 5, 2007

(54) Method of manufacturing donor film for OLED and method of manfacturing using the donor film

(76) Inventors: Joon-Yong Park, Yongin-si (KR); Sang-Yeol Kim, Gwacheon-si (KR); Sung-Hun Lee, Seoul (KR); Young-Mok Son, Hwaseong-si (KR)

Correspondence Address: Robert E. Bushnell, Suite 300, 1522 K Street, N.W., Washington, DC, 20005, US

(21) Appl. No.: 11/606,967

(22) Filed: Dec. 1, 2006

(30) Foreign Application Priority Data
Jan. 5, 2006 (KR) 10-2006-0001396

(51) Int. Cl. B44C 1/165; B44C 1/17; D06N 7/00

(52) U.S. Cl. 156/230; 156/231; 156/240

(57) ABSTRACT

A method of manufacturing a donor film for an organic light-emitting device (OLED) and a method of manufacturing an OLED having the donor film are provided. The method of manufacturing the donor film for an organic light-emitting device including preparing a base film, and forming an organic luminescence layer pattern by a dispensing method in which a fluid organic material is ejected on the base film through a dispenser needle. The method of manufacturing an organic light-emitting device by the use of the donor film including preparing a first electrode pattern on a substrate, preparing a donor film having an organic luminescence layer pattern that matches the first electrode pattern, transferring the organic luminescence layer pattern of the donor film to the substrate to form a organic luminescence layer pattern on the first electrode pattern, and forming a second electrode on the organic luminescence layer formed on the first electrode pattern.

### CLAIM OF PRIORITY

This application makes reference to, incorporates the same herein, and claims all benefits accruing under 35 U.S.C. §119 from an application for MANUFACTURING METHOD OF DONOR FILM FOR OLED AND MANUFACTURING METHOD OF OLED USING THE SAME earlier filed in the Korean Intellectual Property Office on the 5^{th} of Jan. 2006 and there duly assigned Serial No. 10-2006-0001396.

### BACKGROUND OF THE INVENTION

1. Field of the Invention

The present invention relates to a method of manufacturing a donor film for an organic light-emitting device (OLED) and a method of manufacturing an OLED, and more particularly, to a method of manufacturing a donor film by patterning an organic luminescence layer on a base film in a dispensing process and a method of manufacturing an OLED using the donor film.

2. Description of the Related Art

Organic electroluminescence is a phenomenon used in organic light-emitting devices, e.g., organic light-emitting diodes (OLEDs). In the organic electroluminescence, electrons and holes released by a cathode and an anode, respectively, are injected into an organic film made of a low molecular weight compound or a polymer. The electrons and holes recombine to form an exciton, and light of a specific wavelength is emitted from the organic film when energy of the exciton is released.

Generally, an organic light-emitting device comprises an anode, a cathode, and an organic luminescence layer disposed between the anode and the cathode. The organic luminescence layer may be formed of a plurality of layers each having a different function, and preferably it may constructed of a multi-layer including at least one of an emitting layer, a hole injecting layer (HIL), a hole transporting layer (HTL), a hole blocking layer (HBL), an electron transporting layer (ETL), and an electron injection layer (EIL).

To manufacture the organic light-emitting device, an organic luminescence layer should be formed on a substrate corresponding to an electrode pattern of the substrate. In particular, in order to enable an OLED to display a color image, an organic luminescence layer corresponding to each of various colors may be prepared. To form the organic luminescence layer, a deposition method using a shadow mask can be used for an OLED that is made of a low molecular weight organic material, and an inkjet printing or a laser induced thermal imaging (LITI) method can be used for a polymer OLED. An advantage of the LITI method is that this method is a dry process.

When the organic luminescence layer is formed by the LITI method, it is necessary to have a donor film that has an organic luminescence layer to be transferred on the electrode pattern of the substrate. The donor film includes a light-to-heat conversion layer (LTHC). When a laser beam is irradiated on the LTHC layer in a pattern that is to be formed on the substrate, the energy of the laser beam is transformed into heat energy and then the organic luminescence layer is transferred to the substrate by the heat energy. The LITI method is disclosed, for example, in Korean Patent Publication No. 1998-51844, U.S. Pat. Nos. 5,998,085 and 6,214,520.

In a laser induced thermal imaging method, an organic luminescence layer is formed on an entire donor film. When the organic luminescence layer is transferred form the donor film onto the substrate, it is difficult to isolate a portion of the organic luminescence layer, which is to be transferred, from the rest of the organic luminescence layer. This causes an uneven edge of the transferred organic luminescence layer, and waste of material because the rest of organic luminescence layer cannot be used anymore. Thus, there is a need for a method of manufacturing a donor film to solve the problems described above.

### SUMMARY OF THE INVENTION

The present invention provides a method of manufacturing a donor film, which has an organic luminescence layer pattern formed on a base film, for an organic light-emitting device, so that a problem of pattern separation is prevented, and provides a method of forming the organic luminescence layer pattern on the base film by a dispensing method, so that the edge portion of the organic luminescence layer pattern has a uniform shape.

The present invention also provides a method of manufacturing a donor film for an organic light-emitting device by using a sheet or roll type base film, which is various advantages in manufacturing an organic light-emitting device.

According to an aspect of the present invention, there is provided a method of manufacturing a donor film for an organic light-emitting device including steps of preparing a base film, and forming an organic luminescence layer pattern by ejecting a fluid organic luminescence material on the base film through a dispenser needle.

The organic luminescence layer pattern may be formed by moving the dispenser needle or the base film in a direction while maintaining constant ejecting pressure of the fluid organic luminescence material and maintaining a constant distance between the dispenser needle and the base film.

The organic luminescence layer pattern may be formed by moving the dispenser needle or the base film in a direction while periodically changing ejecting pressure of the fluid organic luminescence material and periodically changing a distance between the dispenser needle and the base film.

The donor film may be formed of a sheet type base film or a roll type base film. When a roll type base film is used, the organic luminescence layer pattern may be formed on a portion of the base film that is located between a supplying roll and a winding roll. The base film is unwound from the supplying roll and is wound around the winding roll after the organic luminescence layer pattern is formed on the portion of the base film.

The width and thickness of the organic luminescence layer pattern may be adjusted by adjusting parameters such as a diameter of the dispenser needle, viscosity of the fluid organic luminescence material, ejecting pressure of the fluid organic luminescence material, a distance between the dispenser needle and the base film, and a relative velocity of the dispenser needle to the base film.

According to another aspect of the present invention, there is provided a method of manufacturing an organic light-emitting device including preparing a first electrode pattern on a substrate, preparing a donor film including an organic luminescence layer pattern that matches the first electrode pattern formed on a base film, transferring the organic luminescence layer pattern of the donor film to the first electrode pattern of the substrate to form an organic luminescence layer pattern on the first electrode pattern, and forming a second electrode on the organic luminescence layer of the first electrode pattern.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a cross sectional view of a donor film for an organic light-emitting device, manufactured by a method constructed as an embodiment of the invention;

FIG. 2 is a plan view of the donor film of FIG. 1;

FIG. 3 is a plan view of a donor film for an organic light-emitting device, manufactured by a method constructed as another embodiment f of the present invention;

FIG. 4 is a perspective view of a roll type donor film of an embodiment of the present invention; and

FIGS. 5A through 5E are views showing processes of manufacturing an organic light-emitting device constructed as an embodiment of the present invention.

### DETAILED DESCRIPTION OF THE INVENTION

In the drawings, like reference numerals refer to elements performing the similar functions. The thickness and size of the elements are exaggerated for clarity reasons.

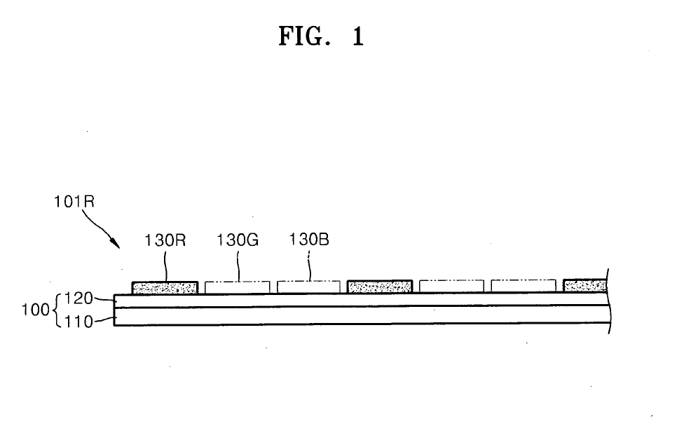

FIG. 1 is a cross sectional view of a donor film 101R for an organic light-emitting device, made by a method of an embodiment of the present invention. Base film 100 is prepared and then organic luminescence layer pattern 130R for one color (for example, red) is regularly formed with a predetermined interval by a dispensing method.

Base film 100 is a light-to-heat conversion film and it may include light-to-heat conversion layer 120 provided on transparent polymer film 110 which allows a laser beam to transmit therethrough. Transparent polymer film 110 may be formed of a material such as polyethylene, polyester, polyacryl, polyepoxy, polystyrene, or the like. In the present embodiment, the transparent polymer film 110 is formed of polyethylene terephthalate. Base film 100 may be formed in a film or a plate shape, and it preferably has good transparency and mechanical stability. Light-to-heat conversion layer 120 absorbs light such as infrared light, ultraviolet light, visible light, etc., and converts part of the absorbed energy of light into heat. Light-to-heat conversion layer 120 has appropriate optical density and includes preferably an optical absorbing material. The material of light-to-heat conversion layer 120 may be an aluminium oxide, an aluminium sulphate, carbon black, graphite, an infrared pigment, etc. Base film 100 is can be a heat conducting film or a porous film that transfers heat produced at a thermal head (not shown) to organic luminescence layer pattern 130R.

Organic luminescence layer pattern 130R includes an organic luminescence film and may further include at least one of an organic hole injecting layer, an organic hole transporting layer, an organic hole blocking layer, an organic electron transporting layer, and an organic electron injecting layer. The organic luminescence layer may be made of a low molecular weight material or a polymer material.

The organic luminescence film, the organic hole injecting layer, the organic hole transporting layer, the organic hole blocking layer, the organic electron transporting layer, and the organic electron injecting layer can be made of a material well-known in the art. An organic luminescence film for emission of red light can be made of a low molecular weight material such as Alq₃ (host)/DCJTB (fluorescent dopant), Alq₃ (host)/DCM (fluorescent dopant), CBP (host)/PtOEP (indium organic metal complex), etc. or a polymer material such as PFO group polymer, PPV group polymer, etc. An organic luminescence film for emission of green light can be made of a low molecular weight material such as DPVBi, spiro-DPVBi, spiro-6P, distilled benzene (DSB), distilled arylene (DSA), etc. or a polymer material such as PFO group polymer, PPV group polymer, etc. An organic luminescence film for emission of blue light can be made of a low molecular weight material such as DPVBi, spiro-DPVBi, spiro-6P, distilled benzene(DSB), distilled arylene (DSA), etc. or a polymer material such as PFO group polymer or PPV group polymer.

The organic hole injecting layer is made of a low molecular weight material such as CuPe, TNATA, TCTA, TDAPB, or a polymer material such as PANI or PEDOT. The organic hole transporting layer is made of a low molecular weight material such as aryl amine group, hydrazone group, still-benzene group, starburst group including NPB, TPD, s-TAD, MTADATA, etc., or a polymer material such as carbazol group, aryl amine group, perillene, or pyrole group including PVK. The organic electron transporting layer is made of a polymer material such as PBD, TAZ, spiro-PBD, or a low molecular weight material such as Alq₃ , Balq, or Salq. The organic electron injecting layer is made of a low molecular weight material such as Alq₃ , Ga complex, PBD, or an oxadiazole group polymer material.

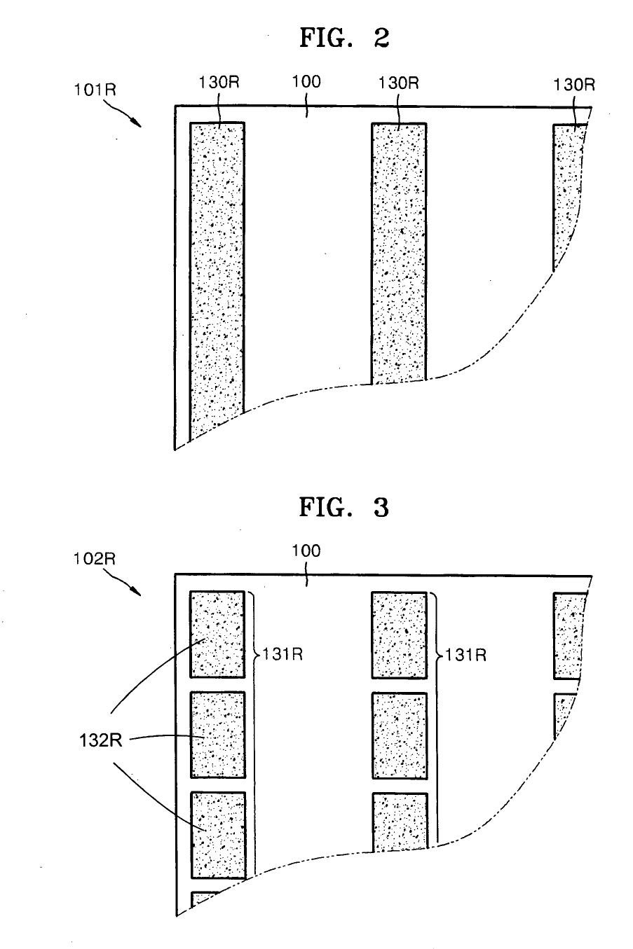

FIG. 2 is a plan view of donor film 101R of FIG. 1. According to an embodiment of the present invention, a single color organic luminescence layer pattern 130R is formed on base film 100 by a dispensing method. In the dispensing method, a fluid organic luminescence material is injected into a syringe, and is dispensed from the syringe via a dispenser needle by applying a desired pressure to the syringe.

In order to form organic luminescence layer pattern 130R, which has the shape of stripes, on base film 100, the dispenser needle linearly moves in a direction (extending direction of the stripe) above base film 100 while ejecting the fluid organic luminescence material onto base film 100 by applying pressure the syringe. After one stripe of organic luminescence layer pattern 130R has been formed, ejecting of the fluid organic luminescence material is stopped and the dispenser needle moves by a predetermined distance perpendicular to the extending direction of the stripe to form another stripe of organic luminescence layer pattern 130R. This movement of the dispenser needle is repeated to form a plurality of stripes of organic luminescence layer pattern 130R. Referring to FIG. 2, organic luminescence layer pattern 130R having stripes is described, but organic luminescence layer pattern 130R can include various shapes and types of pattern, and the same method described above can be applied to make an organic luminescence layer pattern that has other type of pattern than the stipe pattern.

The plurality of stripes of organic luminescence layer pattern 130R can be formed simultaneously using a plurality of dispenser needles regularly located with a certain interval. The distance between the dispenser needles is substantially equal to the distance between the stripes of the organic luminescence layer pattern 130R. When the distance between the stripes is smaller than the diameter of the syringe, the needles may be tilted to dispose the tips of the needles closer to each other and to arrange the tips of the needles at a desired distance.

The relative movement between the dispenser needle (not shown) and base film 100 is performed either by moving the syringe and the dispenser needle while base film 100 is fixed at a position, or by moving a stage (not shown) on which base film 100 is mounted while the syringe and dispense needle are fixed at a position. The distance between the stripes of linear luminescence layer pattern 130R is set to be equal to the distance between the electrodes for the same color pattern. For example, as shown in FIG. 1, when red (R), green (G), and blue (B) organic luminescence layer patterns are necessary, the distance between the stripes of red organic luminescence layer pattern 130R is set in a manner that stripes of green organic luminescence layer patterns 130G and stripes of blue organic luminescence layer pattern 130B can be formed between the nearest two stripes of red organic luminescence layer pattern 130R.

The width and thickness of the stripe of organic luminescence layer pattern 130R can be adjusted by adjusting parameters of the dispensing device. Herein, width of a stripe of an organic luminescence layer pattern is defined as a size of the stripe along a direction perpendicular to the extending direction of the stripe, and thickness of a stripe of an organic luminescence layer pattern is defined as a height of the stripe formed on a base film. The parameters of the dispensing device includes the diameter of the dispenser needle, the viscosity of the fluid organic luminescence material, ejecting pressure applying to the fluid organic luminescence material in a syringe, the distance between the tip of the dispenser needle and the base film, and the relative velocity of the dispenser needle with respect to the base film. For example, if the dispenser needle has a diameter of 80 micrometers, a magnitude of a relative velocity of the dispenser is 200 mm/sec, the viscosity of the organic luminescence layer is 10 cps, and the distance between the tip of the dispenser needle and the base film is 50 micrometers, a stripe of the pattern having a width of 80 micrometers and a thickness of 100 nm is obtained.

The stripe of organic luminescence layer pattern 130R formed in the dispensing method has more uniform thickness in the edges than the stripe of organic luminescence layer pattern formed using an inkjet method. Therefore, the organic luminescence layer pattern 130R transferred to an electrode pattern has an improved profile.

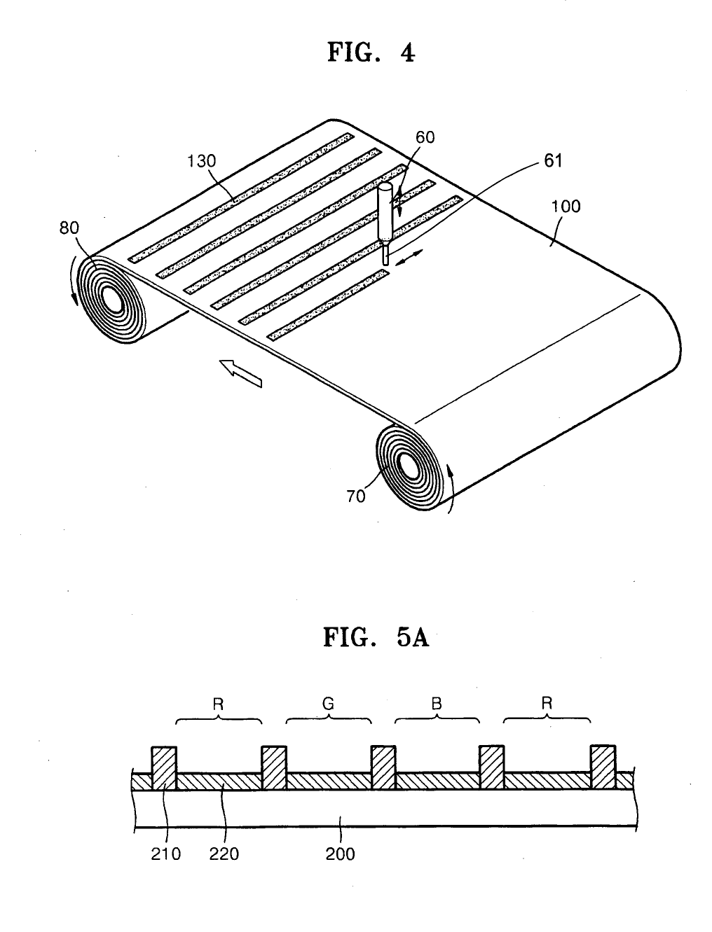

FIG. 3 is a plan view of donor film 102R for an organic light-emitting device, manufacture by a method built as another embodiment of the present invention. The method of the present embodiment is similar to the method described with reference to FIG. 2 except that an organic luminescence layer pattern 131R has a dotted stripe shape. As shown in FIG. 3, dotted stripe 131R has a plurality of sub-stripes 132R.

In this case, the dotted stripe type organic luminescence layer pattern 131R is formed by linearly moving a dispenser needle or base film 100 in a direction (extending direction of the dotted stripe) while periodically changing the ejecting pressure of a syringe and by changing the distance between the dispenser needle and base film 100. For example, the dispenser needle first approaches base film 100 and then moves in a vertical direction as shown in FIG. 3 (extending direction of the dotted stripe). While the distance between the dispenser needle and base film 100 is maintained constant, the dispenser needle ejects a fluid organic luminescence material to form one sub-stripe 132R of the dotted stripe of organic luminescence layer pattern 131R. Then, the needle stops ejecting the fluid organic luminescence material, moves to a next position, and ejects the fluid organic luminescence material to form another sub-stripe of the dotted stripe of organic luminescence layer pattern 131R. These operations are repeated to make a complete dotted stripe type organic luminescence layer pattern 131R. To stop the ejection of the fluid organic luminescence material, the ejecting pressure applied to the syringe is lowered or the flow of the fluid organic luminescence material is cut by closing a valve mounted at the outlet of the dispenser needle. Also, the distance between the dispenser needle and the base film can be adjusted. The position of the dispenser needle is adjusted close to the base film while ejecting the fluid organic luminescence material, but the dispenser needle moves away from the base film when the ejection of fluid organic luminescence material is stopped while the dispenser needle moves to a starting position of another sub-stripe.

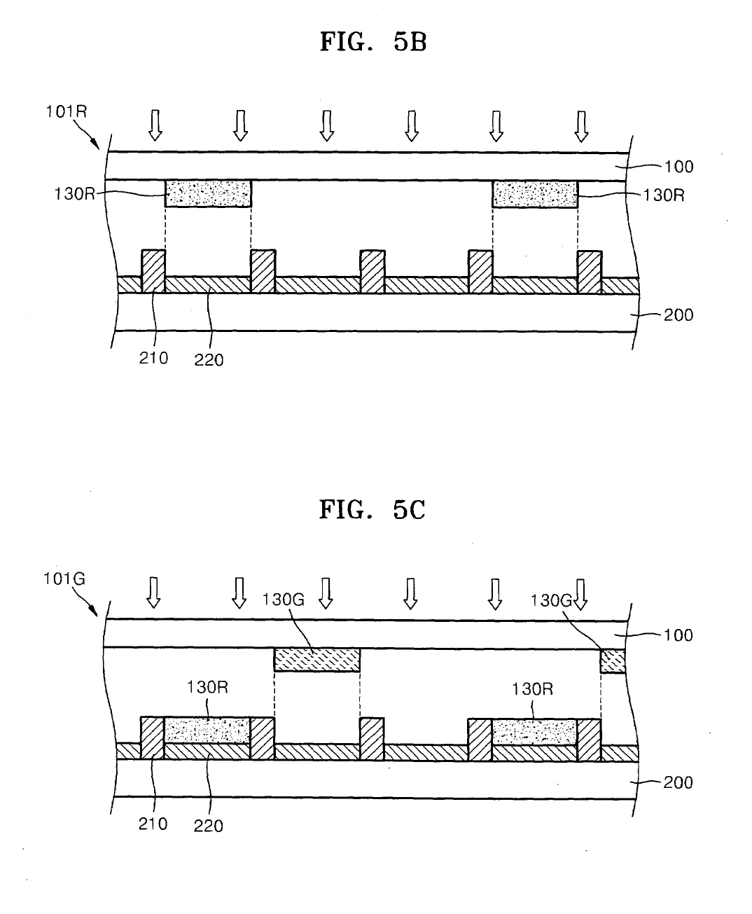

FIG. 4 is a perspective view of a roll type donor film built as an embodiment of the present invention. Dispenser needle 61 installed at a bottom of syringe 60 is located between supplying roll 70 and winding roll 80. As base film 100 is unwound from supplying roll 70 and is wound around winding roll 80, base film 100 moves from supplying roll 70 to winding roll 80, and organic luminescence layer pattern 130 is regularly formed on base film 100. Syringe 60 is mounted at a dispensing head (not shown) and moves in a direction perpendicular to the moving direction of base film 100. A stage (not shown) may be placed under base film 100 to support base film 100.

Supplying roll 70 supplies base film 100, while winding roll 80 winds base film 100. A new portion of base film 100, which does not have any organic luminescence layer pattern, is unwound from supplying roll 70, and a portion of base film 100, on which organic luminescence layer pattern 130 is formed, is wound around winding roll 80. The portion of base film 100, on which organic luminescence layer pattern 130 is formed, becomes a donor film. While base film 100 proceeds from supplying roll 70 to winding roll 80, organic luminescence layer pattern 130 is formed on a portion of base film 100 that is positioned between supplying roll 70 and winding roll 80 in accordance with the above-described dispensing method. After organic luminescence layer pattern 130 is formed on base film 100, organic luminescence layer pattern 130 of base film 100 may be preferably dried before organic luminescence layer pattern-formed base film 100 is wound around winding roll 80.

Hereinafter, an embodiment of a method of manufacturing an organic light-emitting device having a donor film manufactured as described above is explained.

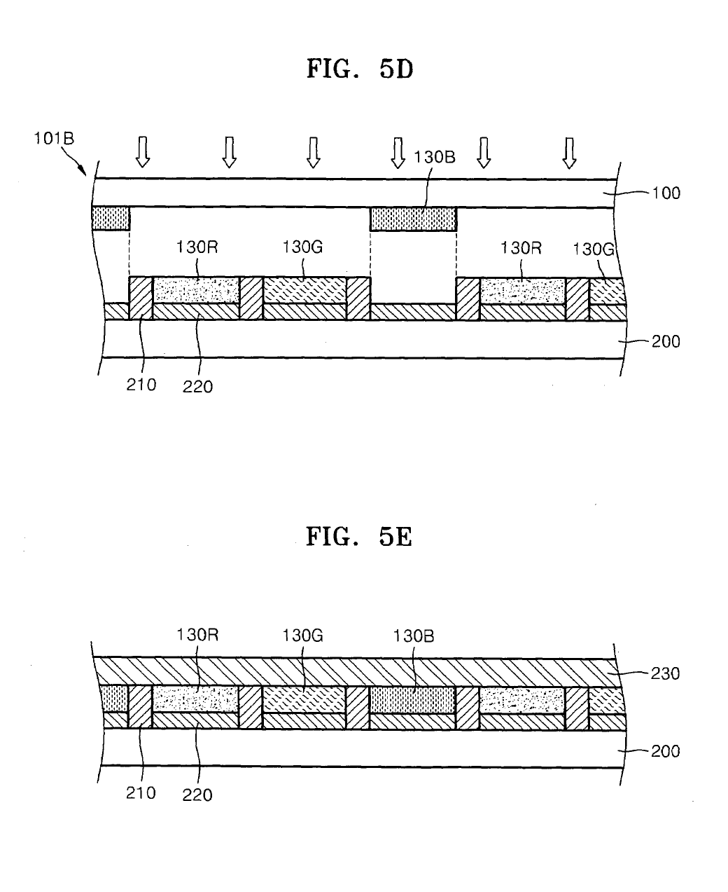

FIGS. 5A through 5E are views for explaining processes of manufacturing the organic light-emitting device constructed as an embodiment of the invention. As shown in FIG. 5A, banks 210 is regularly formed on substrate 200 that formed of glass or plastic. A sub-pixel region is defined as an area located between two nearest banks. FIG. 5A shows three sub-pixel regions R, G, and B. First electrode 220 is formed on substrate 200 in the sub-pixel region, and the arrangement of first electrode 220 forms a first electrode pattern. When a rear emission type organic light-emitting device is manufactured, substrate 200 and first electrode 220 are formed of transparent materials. The transparent electrode material includes indium tin oxide (ITO). In the case of a front emission type organic light-emitting device, first electrode 220 is formed of a metal layer that works as a reflective film.

On the next step, as shown in FIG. 5B, red color donor film 101R having red color organic luminescence layer pattern 130R is placed on substrate 200. Red color organic luminescence layer pattern 130R of red color donor film 101R matches a portion of the first electrode pattern. In other words, red color donor film 101R is prepared such that each stripe of red color organic luminescence layer pattern 130R of red color donor film 101R is aligned with each of red color sub-pixel regions R (shown in FIG. 5A) formed on substrate 200. Then, red color organic luminescence layer pattern 130R is transferred onto first electrode 220 (or first electrode pattern) of the corresponding red color sub-pixel regions.

The method of transferring red color organic luminescence layer pattern 130R onto first electrode 220 may depend on the type of base film 100. If base film 100 includes a light-to-heat conversion layer 120 as described referring to FIG. 1, light such as a laser beam is irradiated through a rear surface of donor film 101R. The light may be irradiated only onto a region of transfer or irradiated onto the entire surface of donor film 101R. If base film 100 is a heat transfer type, heat is directed to the rear surface of donor film 101R using a thermal head. At this time, heat may be applied only to a region of transfer or to the entire surface of donor film 101R.

On the next step, as shown in FIG. 5C, after red organic luminescence layer pattern 130R is transferred onto first electrode 220 of red color sub-pixel regions, green color donor film 101G having green color organic luminescence layer pattern 130G is placed on substrate 200. Green color donor film 101G is arranged such that each stripe of green color organic luminescence layer pattern 130G is aligned with each of green color sub-pixel regions G (shown in FIG. 5A) formed on the substrate 200. Then, green color organic luminescence layer pattern 130G is transferred onto first electrode 220 of the corresponding green color sub-pixel regions. The method of transferring green color organic luminescence layer pattern 130G is the same as the method for red donor film 101R.

As shown in FIG. 5D, after red and green organic luminescence layer patterns 130R and 130G are transferred onto first electrodes 220 of red color and green color sub-pixel regions, blue color donor film 101B having blue color organic luminescence layer pattern 130B is placed on substrate 200. Blue color donor film 101B is arranged such that each stripe of blue color organic luminescence layer pattern 130B is aligned with each of blue color sub-pixel regions B (shown in FIG. 5A) formed on the substrate 200. Then, blue color organic luminescence layer pattern 130B is transferred onto first electrode 220 of the corresponding blue color sub-pixel regions. The method of transferring blue color organic luminescence layer pattern 130B is the same as the method for red and green donor films 101R and 101G.

As shown in FIG. 5E, second electrode 230 is formed on the top of red, green, and blue organic luminescence layers 130R, 130G, and 130B. When a rear emission type organic light-emitting device is manufactured, second electrode 230 may be formed of a metal film that has high conductivity and also has high reflectivity to work as a reflective film. In the case of a front emission type light-emitting device, second electrode 230 may be formed of a transparent electrode material.

According to the method of manufacturing a donor film for an organic light-emitting device of the present invention, an organic luminescence layer pattern is prepared on a base film so that a separation problem of the pattern is resolved and unnecessary waste of the organic luminescence layer material is prevented. Also, since a dispensing method is used to form the organic luminescence layer pattern, an edge portion of the pattern has a uniform shape. In addition, since a sheet or roll type donor film can be used in this method, processes of manufacturing an organic light-emitting device become more effective.

While the present invention has been particularly shown and described with reference to exemplary embodiments thereof, it will be understood by those of ordinary skill in the art that various changes in form and details maybe made therein without departing from the spirit and scope of the present invention as defined by the following claims.

What is claimed is:

1. A method of manufacturing a donor film for an organic light-emitting device comprising: preparing a base film;
ejecting a fluid organic luminescence material on the base film through a dispenser needle; and
forming an organic luminescence layer pattern on the base film, the organic luminescence layer pattern being made of the fluid organic luminescence material ejected through the dispenser needle.

2. The method of claim 1, wherein the organic luminescence layer pattern includes a plurality of stripes being spaced apart from each other.

3. The method of claim 2, further comprising:
moving the dispenser needle or the base film in a direction to form each of the stripes on the base film;
maintaining constant ejecting pressure of the fluid organic luminescence material while forming the stripes on the base film; and
maintaining a constant distance between the dispenser needle and the base film.

4. The method of claim 1, wherein the organic luminescence layer pattern includes a plurality of dotted stripes being spaced apart from each other, each of the dotted stripes including a plurality of sub-stripes.

5. The method of claim 4, further comprising:
moving the dispenser needle or the base film in a direction to form each of the dotted stripes on the base film;
maintaining constant ejecting pressure of the fluid organic luminescence material while forming each of the sub-stripes on the base film;
changing the ejecting pressure of the fluid organic luminescence material while not forming the sub-stripes on the base film; and
changing a distance between the dispenser needle and the base film while not forming the sub-stripes on the base film.

6. The method of claim 1, further comprising:
unwinding the base film from a supplying roll to prepare the base film; and
winding the base film around a winding roll after the step of forming an organic luminescence layer pattern on the base film.

7. The method of claim 2, further comprising:
determining a width and a thickness of each of the stripes, which further includes a step selected from the group consisting of:
adjusting a diameter of the dispenser needle,
adjusting viscosity of the fluid organic luminescence material,
adjusting ejecting pressure applying to the fluid organic luminescence material,
adjusting a distance between the dispenser needle and the base film, and
adjusting relative velocity of the dispenser needle to the base film.

8. A method of manufacturing an organic light-emitting device, comprising:
forming a first electrode pattern on a substrate;
preparing a donor film including an organic luminescence layer pattern that matches a portion of the first electrode pattern formed on the substrate, further including:
preparing a base film; and
forming the organic luminescence layer pattern on the base film by ejecting a fluid organic luminescence material on the base film through a dispenser needle;
aligning the organic luminescence layer pattern of the donor film with the portion of the first electrode pattern of the substrate;
transferring the organic luminescence layer pattern of the donor film to the portion of the first electrode pattern of the substrate to form an organic luminescence layer pattern on the first electrode pattern; and
forming a second electrode on the organic luminescence layer pattern of the first electrode pattern.

9. The method of claim 8, further comprising:
preparing another donor film including another organic luminescence layer pattern that matches another portion of the first electrode pattern formed on the substrate;
aligning the another organic luminescence layer pattern of the another donor film with the another portion of the first electrode pattern of the substrate; and
transferring the another organic luminescence layer pattern of the another donor film to the another portion of the first electrode pattern of the substrate to form another organic luminescence layer pattern on the first electrode pattern.

10. The method of claim 8, wherein the organic luminescence layer pattern of the donor film includes a plurality of stripes being spaced apart from each other.

11. The method of claim 10, further comprising:
moving the dispenser needle or the base film in a direction to form each of the stripes on the base film;
maintaining constant ejecting pressure of the fluid organic luminescence material while forming the stripes on the base film; and
maintaining a constant distance between the dispenser needle and the base film.

12. The method of claim 8, wherein the organic luminescence layer pattern includes a plurality of dotted stripes being spaced apart from each other, each of the dotted stripes including a plurality of sub-stripes.

13. The method of claim 12, further comprising:
moving the dispenser needle or the base film in a direction to form each of the dotted stripes on the base film;
maintaining constant ejecting pressure of the fluid organic luminescence material while forming each of the sub-stripes on the base film;
changing the ejecting pressure of the fluid organic luminescence material while not forming the sub-stripes on the base film; and
changing a distance between the dispenser needle and the base film while not forming the sub-stripes on the base film.

14. The method of claim 8, wherein the step of preparing a donor film further comprising:
unwinding the base film from a supplying roll to prepare the base film; and
winding the base film around a winding roll after the step of forming an organic luminescence layer pattern on the base film.

15. The method of claim 10, further comprising:
determining a width and a thickness of each of the stripes, which further includes a step selected from the group consisting of:
adjusting a diameter of the dispenser needle,
adjusting viscosity of the fluid organic luminescence material,
adjusting ejecting pressure applying to the fluid organic luminescence material,
adjusting a distance between the dispenser needle and the base film, and
adjusting relative velocity of the dispenser needle to the base film.
